(19) United States
(12) Patent Application Publication
(10) Pub. No.: US 2015/0270757 A1
(43) Pub. Date: Sep. 24, 2015

(54) FAN MOTOR

(71) Applicant: NEW MOTECH CO.,LTD., Gwangju (KR)

(72) Inventors: Jeong Cheol Jang, Gwangju (KR); Gyeong Su Park, Gwangju (KR); Woo Sung Cho, Gwangju (KR)

(73) Assignee: NEW MOTECH CO., LTD., Gwangju (KR)

(21) Appl. No.: 14/432,475

(22) PCT Filed: Oct. 15, 2013
(86) PCT No.: PCT/KR2013/009183

§ 371 Date: Mar. 30, 2015

(30) Foreign Application Priority Data
Jan. 4, 2013 (KR) 10-2013-0001144

(51) Int. Cl. H02K 5/04; H02K 11/00

(52) U.S. Cl. CPC H02K 5/04; H02K 11/0068

(57) ABSTRACT

The present invention relates to a fan motor having a stator core, a rotor and a rotary shaft rotatably coupled to the rotor, the fan motor including: a PCB cover having a bottom portion, an outside wall portion and an inside wall portion; and a PCB coupled to the internal space defined by the bottom portion, the outside wall portion and the inside wall portion of the PCB cover, wherein the stator core has an outer peripheral portion, teeth portions formed radially along the outer peripheral portion and at least one or more protrusion portions formed on the outer peripheral portion, and the PCB cover is thus coupled to the protrusion portions of the stator core.

### TECHNICAL FIELD

The present invention relates to a fan motor used to circulate air in an electric device like a refrigerator, and more particularly, to a fan motor that is provided with a stator core and a printed circuit board (hereinafter, referred to simply as “PCB”) cover newly improved in their structure.

### BACKGROUND ART

Like a general motor, a fan motor also includes a stator and a rotor. The stator has a coil wound on a stator core, and the coil is electrically connected to a PCB. Before the coil is wound on the stator core, the surface of the stator core should be insulated. Accordingly, an insulator made of an insulating resin is first coupled to the upper and lower portions of the stator core, and next, the coil is wound on the stator core.

Examples of the fan motors in the conventional practice are disclosed in Korean Patent Nos. 10-1012243 and 10-1012181.

According to the above-mentioned conventional fan motors, a PCB cover and a PCB are coupled to an insulator surrounding a stator core, so that a separate mold for making the insulator is needed and a process for coupling the insulator, the PCB cover and the PCB to one another is further needed, which undesirably increases the manufacturing cost.

So as to solve the above-mentioned problems, accordingly, this inventors have propose a fan motor having a structure wherein a stator core is made through powder compression molding and a PCB cover is directly coupled to the stator core, without having any separate insulator.

### DISCLOSURE OF INVENTION

### Technical Problem

Accordingly, the present invention has been made in view of the above-mentioned problems occurring in the prior art, and it is an object of the present invention to provide a fan motor that is provided with a stator core having a new structure.

It is another object of the present invention to provide a fan motor that has a new structure wherein a stator core on which no insulator is mounted is directly coupled to a PCB cover.

It is yet another object of the present invention to provide a fan motor that is capable of reducing manufacturing cost.

### Solution to Problem provided a fan motor having a stator core, a rotor and a rotary shaft rotatably coupled to the rotor, the fan motor including: a PCB cover having a bottom portion, an outside wall portion and an inside wall portion; and a PCB coupled to the internal space defined by the bottom portion, the outside wall portion and the inside wall portion of the PCB cover, wherein the stator core has an outer peripheral portion, teeth portions formed radially along the outer peripheral portion and at least one or more protrusion portions formed on the outer peripheral portion, and the PCB cover is thus coupled to the protrusion portions of the stator core.

According to the present invention, desirably, the PCB cover has a sealing material filled into the internal space of the PCB cover.

According to the present invention, desirably, the outside wall portion of the PCB cover has lead wire introduction portions formed thereon and lead wire fixing portions formed around the lead wire introduction portions to form given spaces thereinto, into which a fixing block is inserted to fix the lead wires thereto.

According to the present invention, desirably, the outside wall portion of the PCB cover has lead wire introduction portions formed thereon and lead wire guide portions formed around the lead wire introduction portions.

According to the present invention, desirably, the inside wall portion of the PCB cover has at least one or more PCB height guides formed on the outer periphery thereof.

### Advantageous Effects of Invention

According to the present invention, the fan motor has a new structure wherein the PCB cover can be directly coupled to the stator core, without having any separate insulator, thereby reducing the manufacturing cost.

### BRIEF DESCRIPTION OF DRAWINGS

FIG. 1 is a sectional view showing a structure of a fan motor according to a first embodiment of the present invention.

FIG. 2 is a perspective view showing a stator core used in the fan motor according to the first embodiment of the present invention.

FIG. 3 is a perspective view showing a PCB cover of the fan motor according to the first embodiment of the present invention.

FIG. 4 is a perspective view showing a PCB of the fan motor according to the first embodiment of the present invention.

FIG. 5 is a sectional view showing a structure of a fan motor according to a second embodiment of the present invention.

FIG. 6 is a perspective view showing a PCB cover of the fan motor according to the second embodiment of the present invention.

### MODE FOR THE INVENTION

Hereinafter, an explanation on a fan motor according to the preferred embodiments of the present invention will be in detail given with reference to the attached drawings.

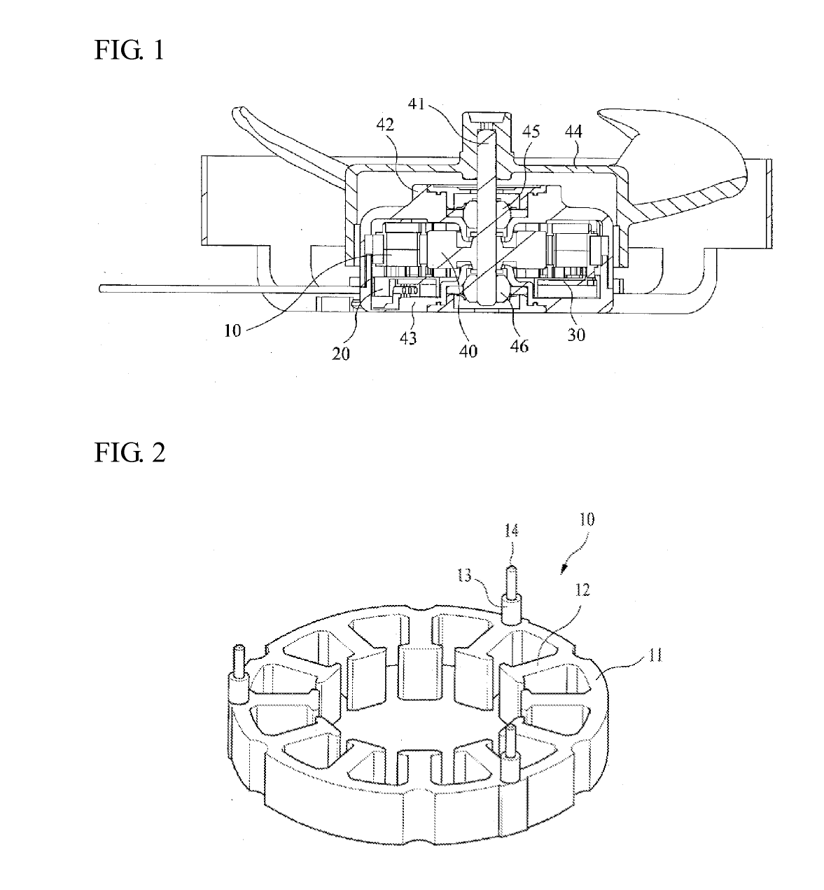

FIG. 1 is a sectional view showing a structure of a fan motor according to a first embodiment of the present invention.

As shown in FIG. 1, a fan motor according to a first embodiment of the present invention includes a stator core 10, a PCB cover 20, a PCB 30 and a rotor 40.

The stator core 10 has a coil (not shown) wound on the teeth portions formed radially along the inner periphery thereof. The end of the coil is electrically connected to the PCB 30 mounted in the PCB cover 20.

The PCB cover 20 is coupled to the underside portion of the stator core 10, and the coupling protrusions formed on the stator core 10 are passed through the bottom portion of the PCB cover 20 and coupled to the coupling holes formed on the PCB 30, thereby coupling the stator core 10 and the PCB cover 20 in which the PCB 30 is mounted. The detailed structure will be explained later with reference to the attached drawing.

The rotor 40 has a rotary shaft 41 coupled to the center thereof and is rotatably located on the center of the inside portion of the stator core 10. If the rotary shaft 41 is rotated together with the rotor 40, a fan 44 coupledly fitted to the end periphery of the rotary shaft 41 is also rotated.

The stator core 10, the PCB cover 20, the PCB 30 and the rotor 40 are protected by means of an upper bracket 42 and a lower bracket 43. That is, the stator core 10, the PCB cover 20, the PCB 30 and the rotor 40 are located at the internal space formed by coupling the upper bracket 42 and the lower bracket 43 each other and thus protected from external space. In case of a fan motor for a refrigerator, especially, the upper bracket 42 and the lower bracket 43 are desirably sealed after coupled to each other so as to prevent moisture from permeating into the interior thereof.

The upper bracket 42 and the lower bracket 43 have an upper bearing 45 and a lower bearing 46 mounted at their center, which allows the rotary shaft 41 to be gently rotated.

FIG. 2 is a perspective view showing a stator core used in the fan motor according to the first embodiment of the present invention.

Referring to FIG. 2, the stator core 10 includes an outer peripheral portion 11, teeth portions 12, protrusion portions 13 and coupling protrusions 14.

According to the present invention, desirably, the stator core 10 is made through compression molding of soft magnetic powder. That is, the soft magnetic powder is filled into a mold made to a shape as shown in FIG. 2, and next, the compression molding for the soft magnetic powder is conducted in a state of a high temperature and a high pressure. As a result, the protrusion portions 13 and the coupling protrusions 14 are formed unitarily with the stator core 10. In the conventional practice, the stator core is made by laminating thin steel plates on each other, and in this case, the outer peripheral portion and the teeth portions are formed. At this time, unfortunately, it is impossible to form the protrusion portions and the coupling protrusions upon making the stator core. According to the present invention, however, the teeth portions 12 are formed radially along the outer peripheral portion 11 of the stator core 10, and at the same time, at least one or more protrusions portions 13 are formed on the outer peripheral portion 11. If necessary, further, the coupling protrusions 14 are formed extended from the protrusion portions 13, thereby coupling the PCB cover 20 and the PCB 30 directly to the stator core 10. The stator core 10 as shown in FIG. 2 shows the state wherein the upper and lower portions are located reversely to those of the fan motor as shown in FIG. 1. That is, in FIG. 1, the PCB cover 20 and the PCB 30 are located on the underside of the stator core 10, but in FIG. 2, the protrusion portions 13 and the coupling protrusions 14 are formed on the top portion of the stator core 10 to couple the PCB cover 20 and the PCB 30 to the top portion of the stator core 10. If there is no specific mention in the present invention, the upper portion and the lower portion mentioned in the present invention are based upon those as shown in FIG. 1.

According to the present invention, further, the stator core 10 desirably has the surface insulated through powder coating, so that there is no need for the introduction of an insulator made of an insulating resin for insulating the stator core 10 in the conventional practice. In more detail, the surface of the stator core 10 made through the compression molding is insulated through powder coating of insulating powder. The coil is wound on the teeth portions 12 of the stator core 10 insulated, and as power is applied to the coil, a magnetic flux around the stator core 10 can be controlled. Of course, even if the existing insulator is introduced, without having any insulating powder coating, the PCB cover 20 and the PCB 30 can be directly coupled to the stator core 10 by passing the protrusion portions 13 and the coupling protrusions 15 through the insulator.

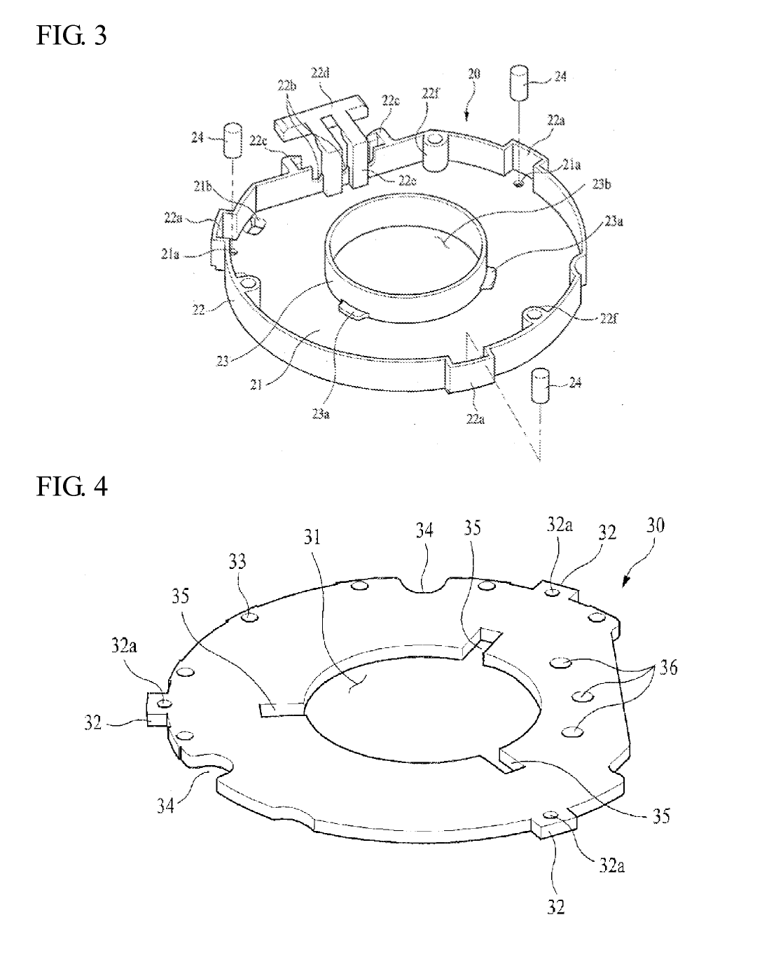

FIG. 3 is a perspective view showing a PCB cover of the fan motor according to the first embodiment of the present invention.

As shown in FIG. 3, the PCB cover 20 in the fan motor according to the first embodiment of the present invention largely includes a bottom portion 21, an outside wall portion 22 and an inside wall portion 23.

The PCB 30 is mounted in the internal space defined by the bottom portion 21, the outside wall portion 22 and the inside wall portion 23 of the PCB cover 20. After the PCB 30 is mounted, the lead wire and the coil as power lines are electrically connected to the PCB 30, and a sealing process is conducted to the space in which the PCB 30 is located by means of a sealing material like curing sealant.

Insertion holes 21a are formed on the bottom portion 21, through which the coupling protrusions 14 formed on the protrusion portions 13 of the stator core 10 are passed. Accordingly, the number of insertion holes 21a is equal to the number of protrusion portions 13 and the number of coupling protrusions 14, respectively. The coupling protrusions 14 passed through the insertion holes 21a are passed through the insertion holes of the PCB 30 mounted inside the PCB cover 20. In the state where the PCB 30 is mounted inside the PCB cover 20, the protruded portions of the coupling protrusions 14 after passing are coupled to caps 24. So as to ensure the space portions of the caps 24, cap location portions 22a are formed on the outside wall portion 22. In the state where the PCB 30 is mounted inside the PCB cover 20 and the caps 24 are coupledly fitted to the coupling protrusions 14, the sealing material is filled into the interior of the PCB cover 20, thereby conducting the sealing process.

Further, at least one or more coil holes 21b are formed on the bottom portion 21, which provides a passage through which the end of the coil wound on the stator core 10 is passed and electrically connected to the PCB 30.

The outside wall portion 22 has lead wire introduction portions 22b formed thereon.

The lead wire introduction portions 22b are guide portions through which lead wires (not shown) for application of power to the PCB 30 are passed. Lead wire fixing portions 22c are formed around the lead wire introduction portions 22b and have given spaces formed at the inside thereof to insert a fixing block 22d thereinto, thereby fixedly compressing the lead wire thereagainst. Fixing the lead wire through the fixing block 22d prevents the escape of the lead wire at the time when the sealing process is performed in the interior of the PCT cover 20 and thus suppresses the occurrence of poor contact. The fixing block 22d is connected to fixing block stands 22e, and if a slight force is applied to the fixing block 22d, the fixing block 22d is separated from the fixing block stands 22e or bent, thereby being inserted into the internal spaces of the lead wire fixing portions 22c. That is, the fixing block 22d is formed together with the molding of the PCB cover 20, without having any separate manufacturing.

The outside wall portion 22 has at least one or more inner protrusion portions 22f formed on the inner periphery thereof. The inner protrusion portions 22f perform two functions. Firstly, they are located at the guide grooves formed on the PCB 30 to arrange the proper position of the PCB, and secondly, they provide coupling holes (or coupling protrusions) adapted to couple the lower bracket 43 to the PCB cover 20.

The inside wall portion 23 has at least one or more PCB height guides 23a formed on the outer periphery thereof. The PCB height guides 23a maintain the PCB 30 to a given height when the PCB 30 is located inside the PCB cover 20. Accordingly, the sealing material is evenly applied to the top and underside of the PCB 30 during the sealing process, thereby achieving good sealing. The inside wall portion 23 has a hollow portion 23b formed at the inner periphery thereof, in which the lower bracket 43 and the lower bearing 46 are located.

FIG. 4 is a perspective view showing a PCB of the fan motor according to the first embodiment of the present invention.

As shown in FIG. 4, the PCB 30 has a central hole 31 formed thereon, into which the inside wall portion 23 of the PCB cover 20 is inserted.

Further, the PCB 30 has at least one or more coupling protrusion portions 32 formed on the outer periphery thereof, and each coupling protrusion portion 32 has an insertion hole 32a formed thereon. Desirably, the number of coupling protrusion portions 32 is equal to that of coupling protrusions 14 formed on the stator core 10. The coupling protrusion portions 32 are located at the cap location portions 22a of the PCB cover 20.

The PCB 30 has a coil connection portion 33 formed thereon, to which the end of the coil is electrically connected. Alternatively, a pin is coupled to the stator core 10, and the end of the coil is connected to the pin. Next, the end of the pin is connected to the coil connection portion 33. The PCB 30 has guide grooves 34 formed along the outer periphery thereof, into which the inner protrusion portions 22f of the outside wall portion 22 are located, and has hall sensor location portions 35 formed along the inner periphery thereof, to which at least one or more hall sensors (not shown) are connected. Further, the PCB 30 has lead wire connection portions 36 formed thereon, to which the lead wires (not shown) are electrically connected.

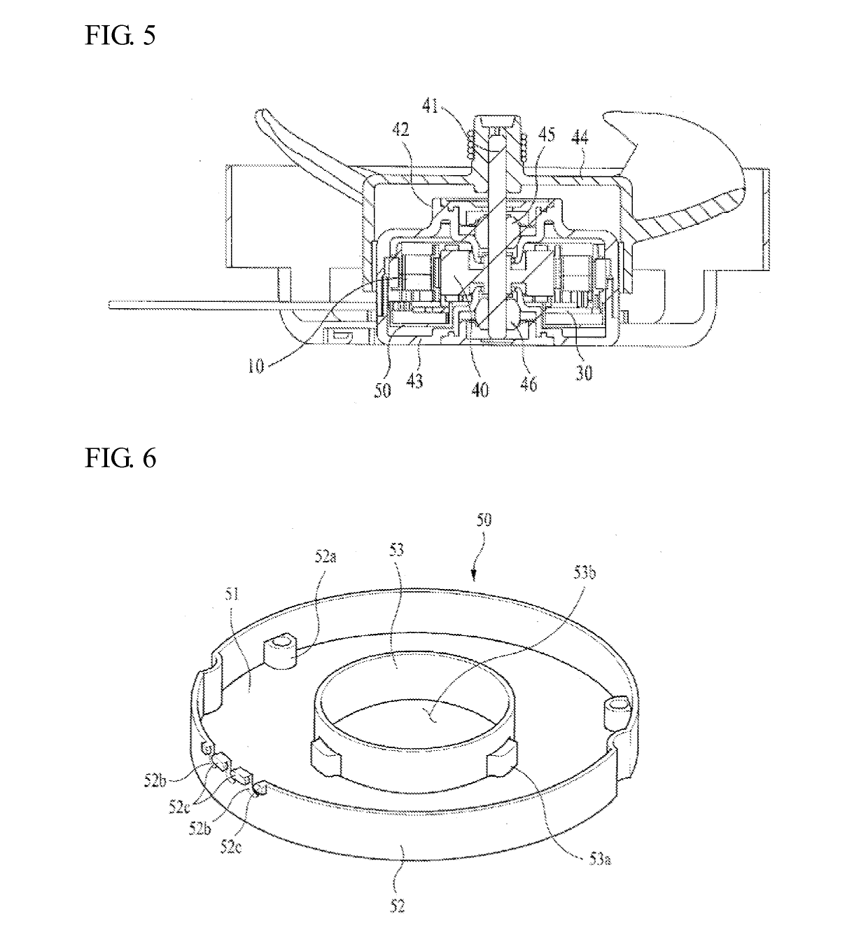

FIG. 5 is a sectional view showing a structure of a fan motor according to a second embodiment of the present invention.

Referring to FIG. 5, the fan motor according to the second embodiment of the present invention has the same structure as that according to the first embodiment of the present invention, except that the PCB cover 20 is changed with a PCB cover 50.

As shown in FIG. 5, the PCB cover 50 in the fan motor according to the second embodiment of the present invention is coupled to the stator core 10 in the state where the open portion thereof is located upward. To the contrary, the PCB cover 20 as shown in FIG. 1 is coupled to the stator core 10 in the state where the open portion thereof is located downward. A detailed structure of the PCB cover 50 will be discussed with reference to FIG. 6.

FIG. 6 is a perspective view showing the PCB cover of the fan motor according to the second embodiment of the present invention.

As shown in FIG. 6, the PCB cover 50 in the fan motor according to the second embodiment of the present invention largely includes a bottom portion 51, an outside wall portion 52 and an inside wall portion 53, and the PCB 30 is located at the internal space defined by the bottom portion 51, the outside wall portion 52 and the inside wall portion 53 of the PCB cover 50.

The outside wall portion 52 has coupling holes 52a formed on the inner periphery thereof at the corresponding locations to the coupling protrusions 14 of the stator core 10, and thus, the coupling protrusions 14 are insertedly coupled to the coupling holes 52a. Further, the outside wall portion 52 has lead wire introduction portions 52b formed thereon. Lead wire guide portions 52c are formed around the lead wire introduction portions 52b. Accordingly, the lead wires are forcedly fit to the lead wire guide portions 52c and fixedly located at the lead wire introduction portions 52b, thereby preventing the lead wires from being escaped from their location during the sealing process.

The inside wall portion 53 has at least one or more PCB height guides 53a formed on the outer periphery thereof and a hollow portion 53b formed at the inner periphery thereof. The PCB height guides 53a and the hollow portion 53b have the same functions as those according to the first embodiment of the present invention.

While the present invention will be described with reference to the particular illustrative embodiments, it is not to be restricted by the embodiment but only by the appended claims. It is to be appreciated that those skilled in the art can change or modify the embodiments without departing from the scope and spirit of the present invention.

1. A fan motor having a stator core, a rotor and a rotary shaft rotatably coupled to the rotor, the fan motor comprising:
a PCB cover having a bottom portion, an outside wall portion and an inside wall portion; and
a PCB coupled to the internal space defined by the bottom portion, the outside wall portion and the inside wall portion of the PCB cover, wherein the stator core has an outer peripheral portion, teeth portions formed radially along the outer peripheral portion and at least one or more protrusion portions formed on the outer peripheral portion, and the PCB cover is thus coupled to the protrusion portions of the stator core.

2. The fan motor according to claim 1, wherein the PCB cover has a sealing material filled into the internal space of the PCB cover.

3. The fan motor according to claim 1, wherein the outside wall portion of the PCB cover has lead wire introduction portions formed thereon and lead wire fixing portions formed around the lead wire introduction portions to form given spaces thereinto, into which a fixing block is inserted to fix the lead wires thereto.

4. The fan motor according to claim 1, wherein the outside wall portion of the PCB cover has lead wire introduction portions formed thereon and lead wire guide portions formed around the lead wire introduction portions.

5. The fan motor according to claim 1, wherein the inside wall portion of the PCB cover has at least one or more PCB height guides formed on the outer periphery thereof.
